(19) United States
(12) Patent Application Publication
(10) Pub. No.: US 2007/0226195 A1
(43) Pub. Date: Sep. 27, 2007

(54) Methods and apparatus for content search using logical relationship taxonomies

(76) Inventor: Mark Mallen Huck, Seattle, WA (US)

Correspondence Address: MARK M. HUCK, 912 2ND AVE. W., SEATTLE, WA, 98119, US

(21) Appl. No.: 11/724,632

(22) Filed: Mar. 16, 2007

Related U.S. Application Data
(63) Continuation of application No. 60/783,918, filed on Mar. 21, 2006.

(51) Int. Cl. G06F 17/30

(52) U.S. Cl. 707/3

(57) ABSTRACT

When search results are returned to an Internet user, the user is limited in next steps to analyze the displayed content. While advanced search options allow the user to search again, these options again return a set of results that are largely independent from each other apart from common words or phrases requested in the query. Some search engines return the results into further categories relating to the search terms themselves, but again the results are linked only by the taxonomy defined in the search query or between the results themselves. The present invention provides two means for providing the user new analytical tools after a search result is returned. First, the user passes all or a subset of the initial search results through a logical relationships taxonomy. The set of terms in this taxonomy is independent of the actual search terms; instead, the taxonomy terms are pre-defined and reflect logical structure instead of a topical taxonomy. By parsing results in this manner, the user is provided an analysis of the combined results. Second, this invention provides the user a way to create and view both the logical relationships between returned results and the strength of those relationships. By doing so, the user better understands how the results relate to each other and to logically adjacent content.

### BACKGROUND OF THE INVENTION

1. Field of the Invention

This invention relates to Class 706 (DATA PROCESSING: ARTIFICIAL INTELLIGENCE), 45 (KNOWLEDGE PROCESSING SYSTEM), 59 (CREATION OR MODIFICATION), 60 (EXPERT SYSTEM OR SHELL).

2. Description

A primary method for users to find information on a network such as the Internet is through search results provided by various search engines. These engines usually provide a text input field into which the user types a query. The site then returns search results containing links to pages or documents which are relevant to the query. This method of information retrieval has become very popular as the results become ever more relevant to the user. Google is currently a company that is prominent in this field. By using a mechanism called “page rank”, whereby the links to a site suggest its accuracy and validity, Google has made network search an extremely accurate way for users to find information.

This search paradigm is particularly useful for atomic pieces of information, such as weather or news, where the user may have enough contextual information to make informed decisions off limited information. As the size of the relevant context increases, however, the value of the individual fact decreases because the fact may be appropriate for only limited situations. Research, for example, may require extensive context in order to understand a limited fact or tosubstantiate an assertion. This context might include date, time, location, preconditions, history, risks, and so forth.

Some search engines present search results in a format that include numerous categories and subcategories by which the results are grouped. The categories can be organized, for example, in multiple layers, or levels, each such layer or level being more specific than the previous one, such as in a hierarchical “category tree”. While this presentation assists in understanding context, it is topical in nature, with categories such as trees:conifers:spruce, rather than logical, such as claims:facts:conclusions. The presentation format, moreover, may be cumbersome, difficult and/or time consuming to utilize, review, navigate, narrow, or analyze. For example, the list of ranked web sites or category paths may span several web pages and require paging through hundreds or thousands of lines of text to analyze search results. Ultimately, the user is forced to click though to each of many pages from the results list to find information, and then must organize it. This behavior has been coined “spidering”, and refers to the repeated effort the user must make to assess and assimilate all the returned search results.

The limitation of this presentation is most acute for users needing to analyze a lot of information. For researchers, as an example, current art does not show a method for the researcher to combine selected results so that related pieces from the selected results are re-combined using a logical relationship taxonomy rather than by the topical taxonomy derived from the search terms. A student might be interested in creating an analysis with issues, facts, assumptions, reasoning, and conclusions as its main sections. On the other hand, a doctor might be interested in symptoms, patient history, diagnosis, and prescriptions whereas a financial analyst might want to parse the search results by market trends, management decisions, and company performance. Currently, there is no mechanism described for doing so from search results.

Yet another difficulty for users is that logical relationships between items in a search result are not apparent. Search results typically display autonomous information, such as a document or web page. However, most of this information exists in some continuum of information in which related information provides valuable context, as does derivative information, and the logical relationships between these content items are as valuable as the content itself in determining relevance. Prior art does not show a search result where these relationships are either calculated into or graphically displayed in the search results. In a simple example, historical facts returned in a search result currently require the end user to search multiple times in order to find those facts earlier (such as causes) and later (such as consequences) than a particular fact. The present invention solves this problem by displaying search results both topically and then each result together with logically preceding and following content.

3. Prior Art

U.S. Pat. No. 6,961,731 (to Holbrook) shows methods for displaying search results by category from a hierarchical dataset. However, the present invention does not display by category but rather by taxonomy. It does not relate to “uncommon level of subcategories” of Holbrook's first independent claim; it does not relate to graphical icons nor result sets of more than 50 as in Holbrook's second independent claim; and the present invention does not relate to “parent and at least one lower level category” of Holbrook's third independent claim.

U.S. Pat. No. 6,704,729 (to Klein, et al.) describes searches where prior categorization of the content is important to the search result. This prior art does not disclose, however, an independent taxonomy of logical relationship types through which the search results are examined by a computer program which then assigns the search results to one or more of the logical relationship types.

U.S. Pat. No. 6,236,987 (to Horowitz, et al.) describes a set of categories that are dynamically derived from the search query and the results returned. However, the application of a pre-defined logical relationship taxonomy is not disclosed. Nor are the logical relationships between content items considered in the weighting of search results.

The present invention solves these problems while providing analytical capabilities not available in the current search paradigm or other prior art. The present invention is partially premised on the idea that it is the relationships and metadata that hold the primary value of content, particularly as the size and complexity of the content increases.

Researchers—legal, medical, academic, and otherwise—will derive surprising benefits from the present invention.

### SUMMARY OF THE INVENTION

The present invention contains three major contributions to knowledge management—corresponding to the independent and dependent claims later in this document—which are not disclosed by prior art.

First, in the present invention the user selects search results from all the results returned by the search engine. Alternately, some of these results may be pre-selected by the system based on relevance or other criteria. The end-user then submits this subset of results and the system then processes them against a logical taxonomy that has been pre-defined by either the user or a system administrator. Some typical analysis taxonomies might be:
ISSUE:FACTS:ASSUMPTIONS:REASONING:CONCLUSIONS,
MARKET:COMPANY:ROI:COMPETITORS:LEGALISSUES
SYMPTOMS:DIAGNOSIS:TESTS:CONDITIONS:TREATMENT

The present invention has a default taxonomy, though this is not required. Each of the key terms in the taxonomy set is called a “type”. A thesaurus associates similar concepts, phrases, or words with each type. When displaying the results, content is searched for these types and similar terms. The results are sorted by type and ranked by a score that is computed from the prevalence of the types and their associated terms.

Logical relationship taxonomies are differentiated from topical taxonomies as follows: 1] if the search query was the logical relationship taxonomy alone, the results would be far too broad to be relevant, and 2] if the search query included the logical relationship taxonomy, the results would be too constrained. Thus, the logical relationship taxonomy is a second order constraint on the search, applied only after the initial topical search has been conducted and topical search results returned. Once the analysis based on the logical relationships is complete, the user may then use additional methods to determine what content within each of the taxonomy elements to further combine into research or a paper. For example, the user may wish to include only the sentence or sentences which have met the criteria of the taxonomy rather than the entire paragraph in which these sentences occur. In addition, the end user may then determine the order of this selected content. The user may also add content before or after each of these selected items, as well as determine formatting. At any time, the user may temporarily persist the selections and undertake another search in order to combine new search results with the persisted selections. The user may also add logical relationships between the items to specify the logic flow of the content. Finally, the user may save within the system and/or to a word document.

Second, the present invention discloses methods which the logical relationships between the content items are computed in the search result relevance algorithm as well as displayed graphically. These logical relationships are important elements of a larger piece of content, such as research, and can aid users in assessing the relevance of that content to their needs. These logical relationships are not explicitly shown in the search results shown in prior art. In the present invention, these logical connections related to each search result are presented in an order that is related to the strength of those connections. For example, a teacher might require her students to submit research where all logical relationship types between content items are explicitly set. The teacher, then, has a way of judging both the student's ability to recognize and assign logical relationships as well as the sum total of weighted logical relationships which could then be compared with other students' works.

Finally, the present invention discloses methods for selecting from search results one or more results to be added into research where these results can be viewed, reordered, logically connected, and annotated. Furthermore, subsequent searches can be performed which can add additional content to this research.

### OBJECTS AND ADVANTAGES

Through one action, such as a button click, the user is presented the top search results related by a logical taxonomy, saving an enormous amount of time “spidering” for relationships between search results. By doing so, the end-user is relieved of constructing this analysis manually from the search results themselves.

A number of systems have been described where a search result is constrained by a topical taxonomy or categorization. The present invention applies a logical taxonomy after the search result is generated, allowing for the taxonomy to contain a separate view of the search results. Thus, when a user would like to see search results on topical keywords DOG:SETTERS:IRISH, the taxonomy can then apply a completely separate logical view such as BREEDING ISSUES: FACTS:ASSUMPTIONS:REASONING:CONCLUSIONS to the original query without diminishing the relevance or scope of the initial query.

Accordingly, the objects and advantages of the present invention are to:
(a) provide a method and apparatus which shows a way to combine multiple search results into a logical framework independent of the topic requested in the original search query, thereby reducing the need to manually reconstruct search results into a logical framework.
(b) provide a method and apparatus which incorporates the logical relationships and their relative strengths into a search result without restricting the original query, giving the user a way to assess the strength of each search result in relation to the logically connected items that may or may not fall within the scope of the original search query.
(c) provide a method and apparatus by which the user can define the logical relationships between content items thereby allowing subsequent users a view into these relationships when a search result is returned to the user.

Further objects and advantages are to make causal relationships between historical facts apparent to users as well as to provide an initial framework for research papers and other analyses. Still further objects and advantages will become apparent from a consideration of the ensuing description and drawings.

### BRIEF DESCRIPTION OF THE DRAWINGS

A typical embodiment of this invention is shown in drawing FIGS. 1-6. The figures should not be considered to limit the scope of the invention, and are shown to represent a typical embodiment of the invention claims.

FIG. 1 shows the general logical taxonomy flow, with suggested user interface displays of the results shown in FIGS. 2 and 3.

FIG. 4 shows the flow of entering logic relationship information into the system, whereas FIGS. 5 and 6 show retrieval and display of this information.

### DETAILED DESCRIPTION OF THE PREFERRED EMBODIMENTS

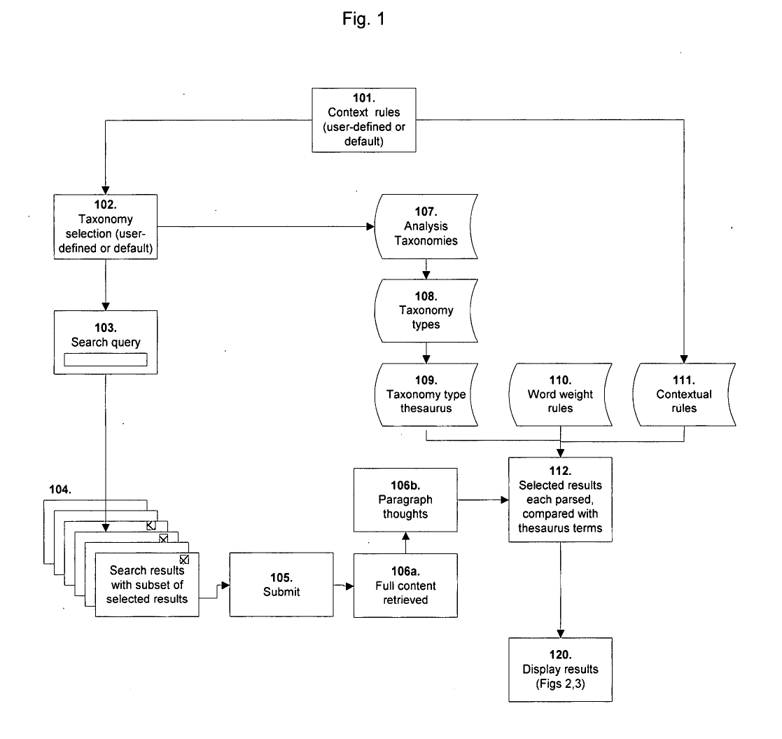

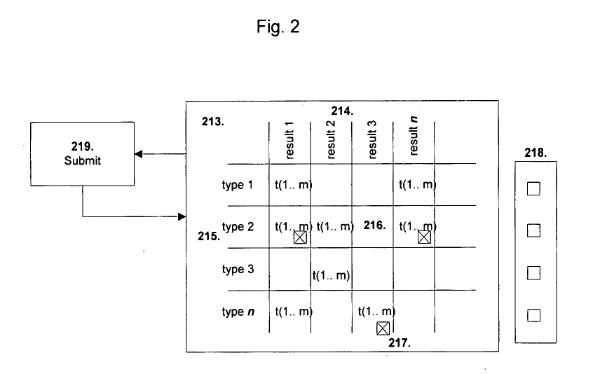

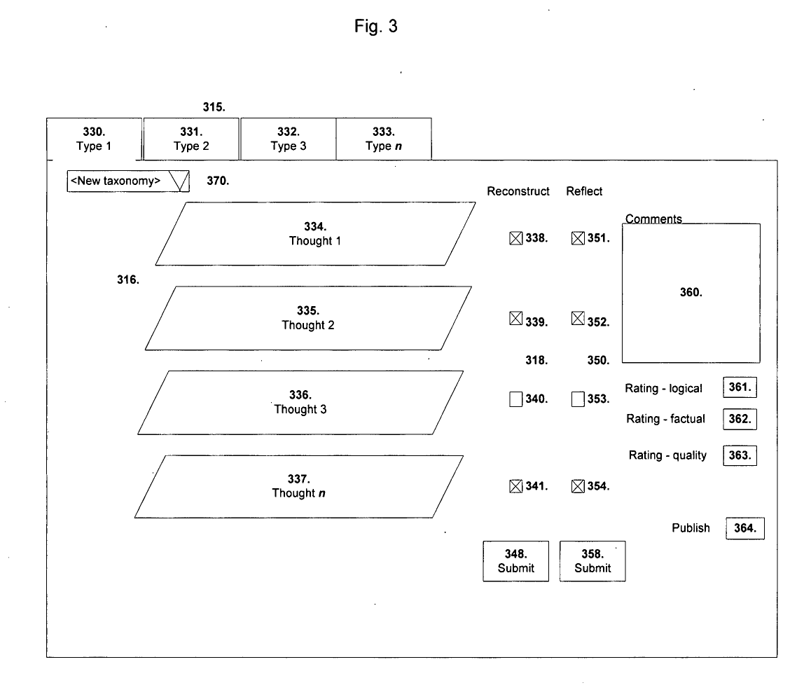

### Description of FIG. 1

Operator may define (101.) or use default rules for operator's contextual rules (111.) that may define attributes such as keywords and processing rules such as word rule weights (110.), ratings of the content, and other search rules. The operator may define rules or use default rules for operator's taxonomy (102.) from a list of available taxonomies (107.) each comprising a series of types (108.) and associated terms in a thesaurus (109.). A search query (103.) is then sent to a search engine, returning a search results (104.). The present invention shows a number of these results pre-selected for submission to the taxonomy filtering. The end-user then submits (105.) the selected results.

The content is retrieved (106a.) and disaggregated into paragraphs or other content unit (106b.). These paragraphs are then searched for synonyms, .via a thesaurus, of the types that make up the taxonomy (112.), and these results are then displayed by relevance to each type.

### Description of FIG. 2

One such display could be in a grid such as is shown in drawing FIG. 2. In this view, the taxonomy types (215.) are shown down the vertical axis and each result (214.) is displayed across the horizontal axis. Within each cell (216.) is the paragraph or thought returned in the type search. Multiple such paragraphs might be displayed in the cell. The end-user can then select (217.) thoughts for deletion or further processing, or may select an entire row (218.) for further processing.

### Description of FIG. 3

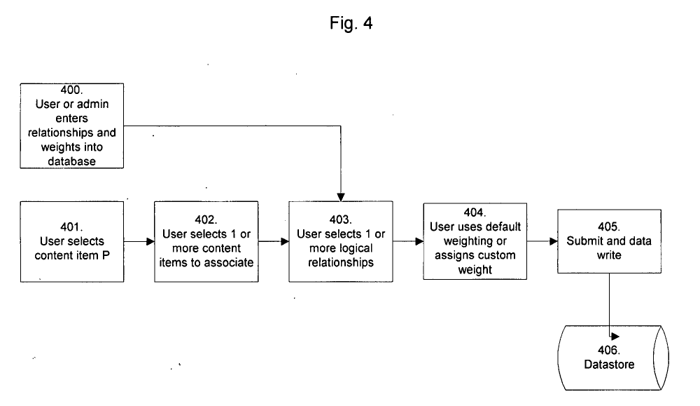

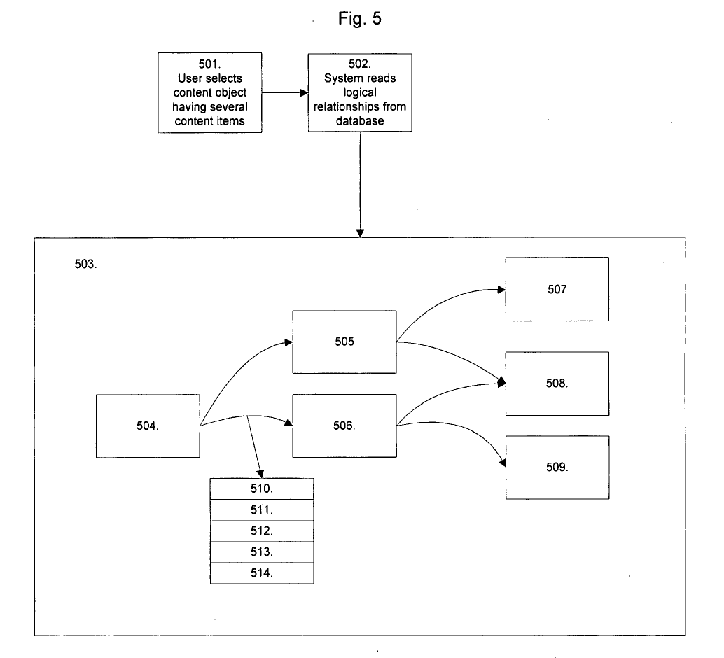

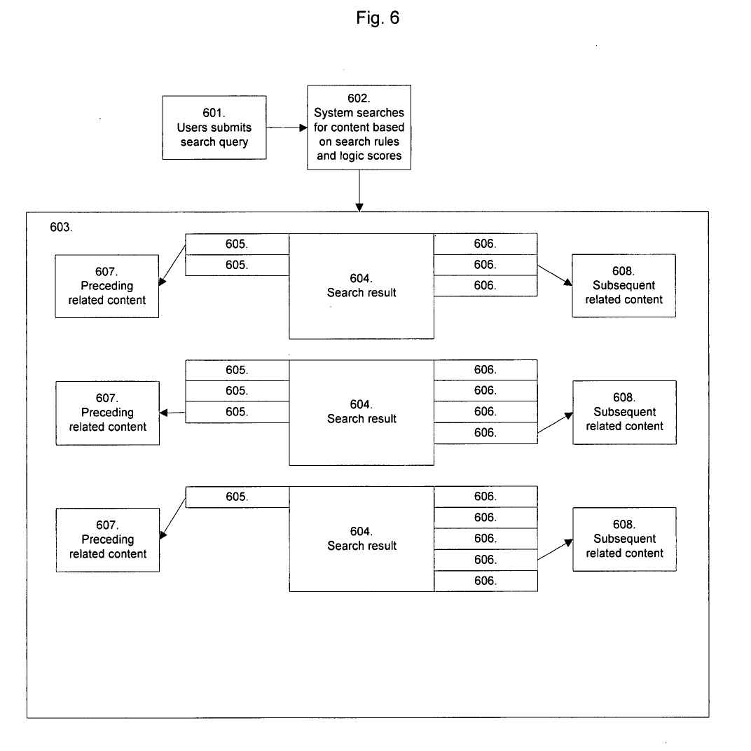

Alternately, the results from the taxonomy filtering can be displayed in a manner similar to FIG. 4. In this view, the types (315.) are displayed as tabs with each tab (330., 331., 332., 333.) representing a taxonomy type. Under each tab are the paragraphs or thoughts (416.) returned as matches to the type from the selected search results. Each result is shown on a separate line or series of lines (334, 335, 336, 337). A series of inputs (318., 338., 339., 340., 341.) are provided to allow the user to re-submit the results to the filtering while excluding some of the earlier results. Further comments (360.) on selected thoughts (350, 351, 352, 353, 354) can create a new knowledge object incorporating both the existing thoughts as well as comments and ratings (361., 362., 363.) by the user. The end-user may also publish (364.) the new object as XML, RSS, RDF, or other format.

The user can take results, either for all types or a specific type, and filter through a different taxonomy (370.).

### Description of FIG. 4

Operator or administrator of operator's system enters logical relationships (400.) into a datastore, assigning a relative weight to each. When two or more content items are presented to user, user may select a principle item (401.) and then select one or more other thoughts (402.) to associate by assigning one or more of the logical relationships (403). The user may accept the default weighting or assign a custom weighting to the relationship (404.) and submit (405.) the association for storage in the datastore (406.)

### Description of FIG. 5

When operator selects or system returns from a search query a content item comprising several component content items (501.), the system processes the input and reads from the a datastore any and all logical relationships that are associated with each of the smaller content items. The system then displays content item (503.) showing each of the component content items (504., 505., 506., 507., 508., 509.). The logical relationships between any two of the component items (510., 511., 512., 513., 514.) are then graphically displayed for the operator as well.

### Description of FIG. 6

When operator submits a search query (601.), the system returns search results based on a pre-defined algorithm (602.). These results are presented in operator's display (603.) such that each search results (604.) contains all or part of the content returned by the system. Logical relationships with preceding content (605.) and subsequent content (606.) are also displayed. These relationship displays show the strength or weight of the logical relationship via color-coding or other graphical means in the order of strength. When the user selects one of the logical relationships (605. or 606.), the content associated with the relationship (607. and 608.) is displayed either in a separate or in the same window as the search results (604.). This related content (607. and 608.) may also be selected for inclusion in the taxonomy analysis (see FIG. 1.)

### CONCLUSIONS, RAMIFICATIONS, AND SCOPE

Accordingly, the reader will see that this invention provides highly functional methods for providing the operator a means for understanding and manipulating the logical relationships between content objects in a knowledge or search system.

Although the description above contains many specificities, these should not be construed as limiting the scope of the invention but as merely providing illustrations of some of the presently preferred embodiments of this invention. Thus, the scope of the invention should be determine by the appended claims and their legal equivalents, rather than by the examples given.

I claim:

1. A method for ordering content obtained from a search result in a computer network comprising
a. providing a memory which is able to store incoming information received over a network into said memory,
b. providing a processor,
c. providing such network devices necessary to connect to a network of computers,
d. providing a display which is operatively connected to such memory,
e. providing a browser program able to transfer and receive information and place such information into memory in a way available to the processor, and showing information on said display,
f. providing a character input means which a human operator can use to enter information into said browser
whereby said method parses the search results content using a pre-defined taxonomy having a set of logical relationship terms which are independent of the search query terms and identifies specific sections of the content which match the rules defined for each term of that taxonomy.

2. The method of claim 1 wherein the results are displayed such that each piece of content that is associated with a term of the taxonomy is juxtaposed with the other pieces of content associated with that term of the taxonomy.

3. The method of claim 2 wherein each part of the piece of content that matches the rules for a term of the taxonomy is highlighted or emphasized.

4. The method of claim 1 wherein the ordering is performed with one-click after the search results have been presented and the operator has selected specific search results to include in the action.

5. The method of claim 1 wherein the ordering is performed prior to the display of the search results.

6. The method of claim 1 wherein the operator is able to select one or more taxonomies from a selection of taxonomies and this selection of taxonomies then operatively orders the results.

7. The method of claim 1 wherein the operator or system administrator pre-defines one or many taxonomies each having a thesaurus containing a plurality of phrases corresponding to each term in the taxonomy set whereby the user may select from one or many of these taxonomies.

8. The method of claim 1 wherein the operator subsequently selects content to further save as research or a paper.

9. The method of claim 1 wherein the operator may then re-order any selected content.

10. The method of claim 4 wherein the operator may also add content before or after each of the selected items prior to the action.

11. The method of claim 1 wherein the user may temporarily persist the selections and undertake another search in order to combine new search results with the persisted selections.

12. The method of claim 8 wherein other operators may subscribe to or purchase the taxonomy.

13. A method for displaying searched content to an operator in a computer network comprising
a. providing a memory which is able to store incoming information received over a network into said memory,
b. providing a processor,
c. providing such network devices necessary to connect to a network of computers,
d. providing a display which is operatively connected to such memory,
e. providing a browser program able to transfer and receive information and place such information into memory in a way available to the processor, and showing information on said display,
f. providing a character input means which a human operator can use to enter information into said browser
wherein the search results display a numeric, color-coded, or other indicator showing the weighted sum or other computation of scores for the logical relationships between each search result and other content logically associated with the content item.

14. The method of claim 13 wherein search algorithm for ascertaining relevance also takes into account a computation of the scores relating to the content items

15. The method of claim 14 wherein manually entered scores by other operators relating to the content are combined with the computation of scores based on the logical relationships between the content item and other content items.

16. A method for adding content in a computer network comprising
a. providing a memory which is able to store incoming information received over a network into said memory,
b. providing a processor,
c. providing such network devices necessary to connect to a network of computers,
d. providing a display which is operatively connected to such memory,
e. providing a browser program able to transfer and receive information and place such information into memory in a way available to the processor, and showing information on said display,
f. providing a character input means which a human operator can use to enter information into said browser
whereby operator assigns logical relationship types between content items.

17. The method of claim 16 wherein each logical relationship type has a weighting factor or score specified by either the operator or a system administrator.

18. The method of claim 17 wherein a second operator can view the sum of all logical weightings within a collection of content items.

19. The method of claim 18 wherein the second operator is provided permission by the operator to view the sum of all logical weightings within a collection of content items created by the operator.

20. The method of claim 16 where one of the content items was pre-existing and the operator creates a new content item and links them with a logical relationship type.
